(19) United States
(12) Patent Application Publication
(10) Pub. No.: US 2017/0094038 A1
(43) Pub. Date: Mar. 30, 2017

(54) MOBILE DEVICE WITH AN IMAGE SENSING MODULE COMMONLY USED BY FRONT LENS AND BACK LENS

(71) Applicant: Arima Communications Corp., Taipei City (TW)

(72) Inventors: SHYH-HUEY CHEN, TAIPEI CITY (TW); JIAN-HUA LI, NEW TAIPEI CITY (TW)

(21) Appl. No.: 15/066,544

(22) Filed: Mar. 10, 2016

(30) Foreign Application Priority Data
Sep. 30, 2015 (CN) 201520769961.9

(51) Int. Cl. H04M 1/02; H04N 5/225

(52) U.S. Cl. CPC H04M 1/0264; H04N 5/2257; H04M 2250/20

(57) ABSTRACT

The disclosure provides a mobile device. A housing comprises an accommodation space. An image sensing module is disposed in the accommodation space of the housing. A front lens is disposed in the accommodation space of the housing, wherein the front lens faces a first direction. A back lens is disposed in the accommodation space of the housing, wherein the back lens faces a second direction and the image sensing module is commonly used by the front lens and the back lens to save cost.

### BACKGROUND OF THE DISCLOSURE

1. Field of the Disclosure

The instant disclosure relates to a mobile device; in particular, to a smart mobile device.

2. Description of Related Art

Mobile devices are computing devices having the size of a pocket. The mobile device usually has a touch-control display screen or a small keyboard thereon. Because mobile devices can store or gather various information at any time and at any place, these devices are widely used.

However, the competition of between makers of mobile devices is more and more great, and the price is lowing down. Therefore, techniques related to how to reduce cost of mobile devices have become important. FIG. 1 shows a three dimensional view of a conventional smart phone. As shown in FIG. 1, a conventional smart phone 100 comprises a front lens 102 and a back lens 104, wherein the front lens 102 is connected to a first image sensing module 106 and the back lens 104 is connected to a second image sensing module 108. This art uses two image sensing modules 106, 108 such that cost of the smart phone 100 using this art is not low enough. In addition, in order to reduce cost, the first image sensing module 106 used by the front lens 102 has less pixel value and the pictures generated have worse quality. In order to reduce cost and increase picture quality taken by the image taking device with the front lens, a new mobile device is required.

### SUMMARY OF THE DISCLOSURE

According to the issue above described, an objective of the instant disclosure is to provide a mobile device which both the front lens and the back lens use the same image sensing module to reduce cost.

According to the issue above described, another objective of the instant disclosure is to provide a mobile device where both the front lens and the back lens use the same image sensing module and the image sensing module has high pixel value to increase the quality of the pictures taken by the photograph taking device in accordance with the front lens.

The disclosure provides a mobile device. A housing comprises an accommodation space. An image sensing module is disposed in the accommodation space of the housing. A front lens is disposed in the accommodation space of the housing, wherein the front lens faces a first direction. A back lens is disposed in the accommodation space of the housing, wherein the back lens faces a second direction and the image sensing module is commonly used by the front lens and the back lens.

The disclosure provides a smart phone. A housing comprising an accommodation space. An image sensing module is disposed in the accommodation space of the housing. A front lens is disposed in the accommodation space of the housing, wherein the front lens faces a first direction. A back lens is disposed in the accommodation space of the housing, wherein the back lens faces a second direction and the image sensing module is commonly used by the front lens and the back lens. A printed circuit board is disposed in the accommodation space. A screen is disposed on the housing.

In an embodiment, the image sensing module is an image sensing chip formed on the printed circuit board.

In an embodiment, the image sensing chip comprises a first surface and a second surface, the first surface is a reverse surface of the second surface, the front lens is adjacent to the first surface of the image sensing chip, and the back lens is adjacent to the second surface of the image sensing chip.

In an embodiment, the image sensing module is an image sensing chip formed on the printed circuit board, the image sensing chip comprises a first surface and a second surface, the first surface is a reverse surface of the second surface, the front lens is adjacent to the first surface of the image sensing chip, and the back lens is adjacent to the second surface of the image sensing chip.

The disclosure has advantages as follows. The front lens and the back lens of the mobile device use the same image sensing module. Therefore, cost of one image sensing module and space of one image sensing module are saved. Accordingly, the mobile device of the disclosure is thinner, smaller and lighter than conventional art to fit the requirement today. In addition, since the first photograph taking assembly in accordance with the front lens uses the same image sensing module as the second photograph taking assembly in accordance with the back lens, both the first photograph taking assembly and the second photograph taking assembly can use an image sensing module having high image quality, such that the pictures taken by the first photograph taking assembly and the second photograph taking assembly have high quality.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 shows a three dimensional view of a conventional smart phone.

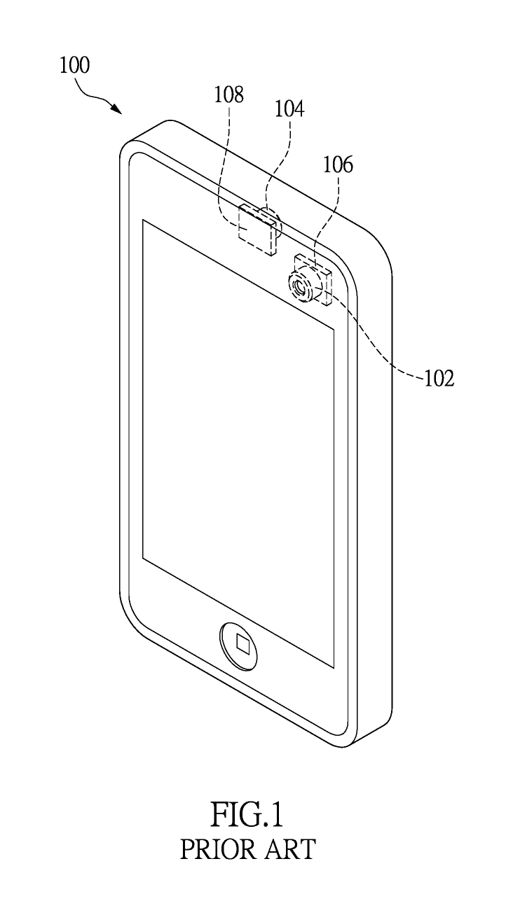

FIG. 2 shows a three dimensional view of a mobile device of an embodiment of the disclosure.

FIG. 3 shows an exploded view of a mobile device of an embodiment of the disclosure.

FIG. 4 shows an exploded view of a mobile device of an embodiment of the disclosure at another viewing angle.

FIG. 5 shows a cross section view of the mobile device of an embodiment of the disclosure.

FIG. 6 shows a schematic view of a wafer-level photograph taking module of an embodiment of the disclosure.

### DETAILED DESCRIPTION OF THE PREFERRED EMBODIMENTS

The aforementioned illustrations and detailed descriptions are exemplary for the purpose of further explaining the scope of the instant disclosure. Other objectives and advantages related to the instant disclosure will be illustrated in the subsequent descriptions and appended drawings.

### First Embodiment

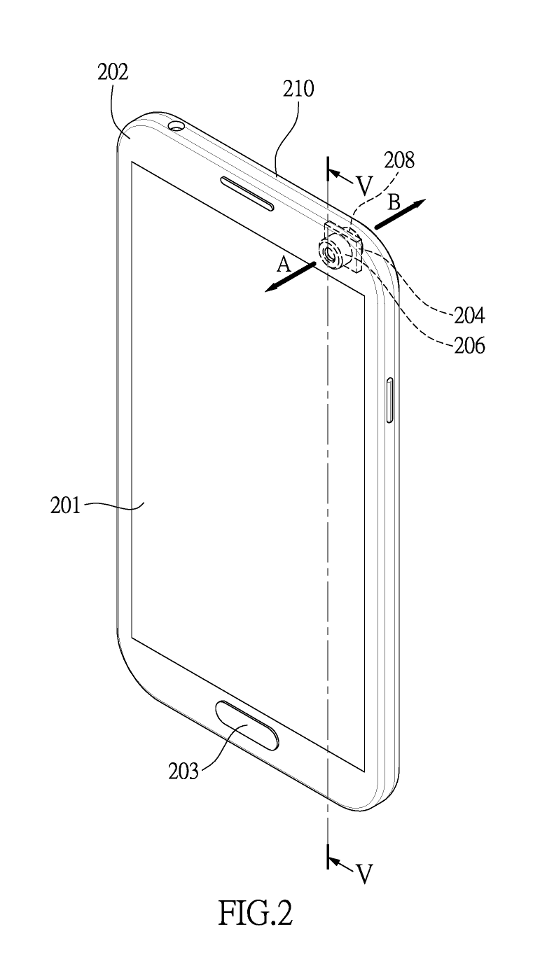

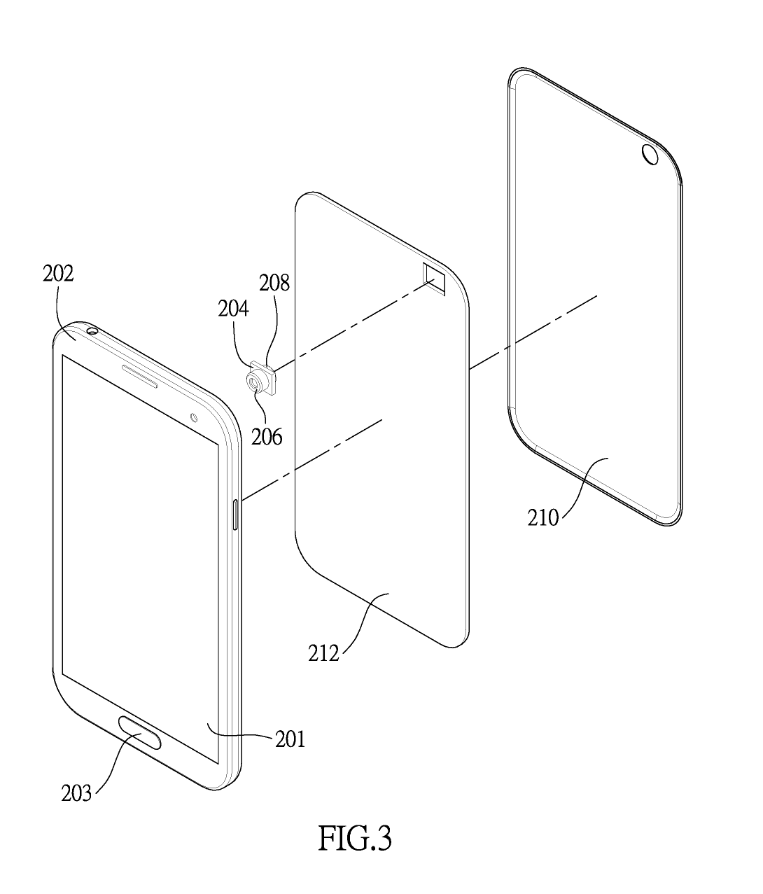

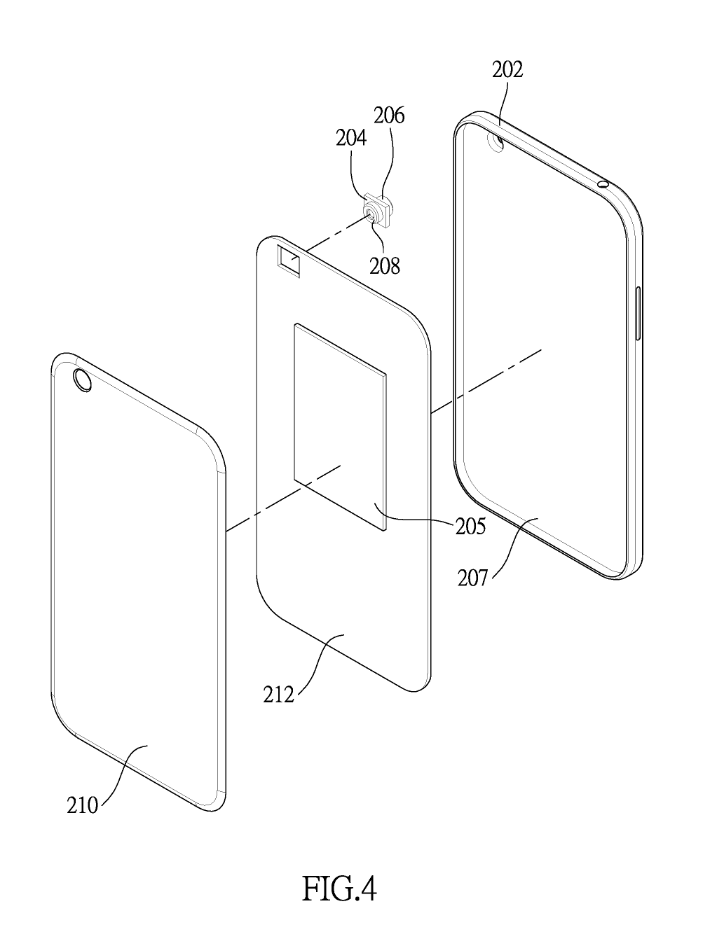

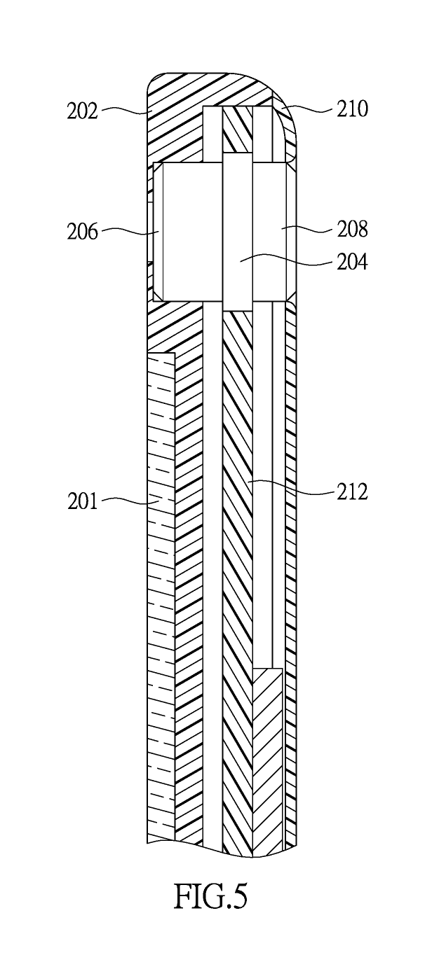

FIG. 2 shows a three dimensional view of a mobile device of the embodiment. FIG. 3 shows an exploded view of a mobile device of the embodiment. Referring to FIG. 2 and FIG. 3, the disclosure discloses a mobile device, and also FIG. 4 and FIG. 5, wherein FIG. 4 shows an exploded view of a mobile device of the embodiment at another viewing angle, and FIG. 5 shows a cross section view of the mobile device of the embodiment. In the embodiment, the mobile device can be a smart phone, but the disclosure is not limited thereto. The mobile device can be a tablet computer or other electronic device. The mobile device of the embodiment comprises a housing 202, an image sensing module 204, a front lens 206, a back lens 208, and a back cover 210. The housing 202 comprises an accommodation space 207 therein, wherein the accommodation space 207 is surrounded by the housing 202 and the back cover 210. The image sensing module 204 is disposed in the accommodation space 207, the front lens 206 is disposed in the accommodation space 207 and the front lens 206 faces a first direction A. The back lens 208 is disposed in the accommodation space 207 and the back lens 208 faces a second direction B, wherein the image sensing module 204 is commonly used by the front lens 206 and the back lens 208.

In more detail, the first direction A is a reverse direction of the second direction B. As well, the first direction A and the second direction B have an included angle therebetween. The front lens 206 is used for the mobile device to take a “selfie” photograph. The back lens 208 is used for the mobile device take a standard photograph. The front lens 206 and the back lens 208 of the mobile device use the same image sensing module 204, such that cost of one image sensing module is saved and space of one image sensing module is also saved. Accordingly, a mobile device which is thinner, smaller and lighter than a conventional device is produced to fit the current requirement.

The back cover 210 is fastened with the housing 202, and an accommodation space 207 of the housing 202 comprises a printed circuit board 212 therein. The image sensing module 204 can be an image sensing chip formed on the printed circuit board 212, wherein the image sensing chip can be a CMOS image sensor. In addition, in an embodiment, the housing 202 includes a screen 201 and a button 203 thereon, and a cell 205 is disposed in the accommodation space 207 of the housing 202. In an example, the image sensing chip 204 has a first surface and a second surface, wherein the first surface is a reverse surface of the second surface. The front lens 206 is adjacent to the first surface of the image sensing chip 204, and the back lens 208 is adjacent to the second surface of the image sensing chip 204. Therefore, even though the front lens 206 and the back lens 208 face different directions, the mobile device can be designed to set the front lens and the back lens to use the same image sensing chip 204.

Because the front lens 206 and the back lens 208 uses the same image sensing module, the front lens 206 and the image sensing module 204 forms a first photograph taking assembly, the back lens 208 and the image sensing module 204 forms a second photograph taking assembly, and the first photograph taking assembly and the second photograph taking assembly have the same pixel value. The device having the design above has advantages as follows. A conventional mobile device is designed to connect the front lens with an image sensing module having less pixel value and connect the back lens with another image sensing module having greater pixel value. The conventional mobile device uses this structure in order to save cost. However, this design makes the picture taken by the front lens have worse picture quality, and the picture taken by the back lens have better picture quality. On the contrary, because the front lens and the back lens use the same lens sensing module in the present embodiment, the mobile device of the disclosure has less cost. In addition, since the first photograph taking assembly in accordance with the front lens uses the same image sensing module as the second photograph taking assembly in accordance with the back lens, the pictures taken by the first photograph taking assembly and the second photograph taking assembly are pictures having high quality.

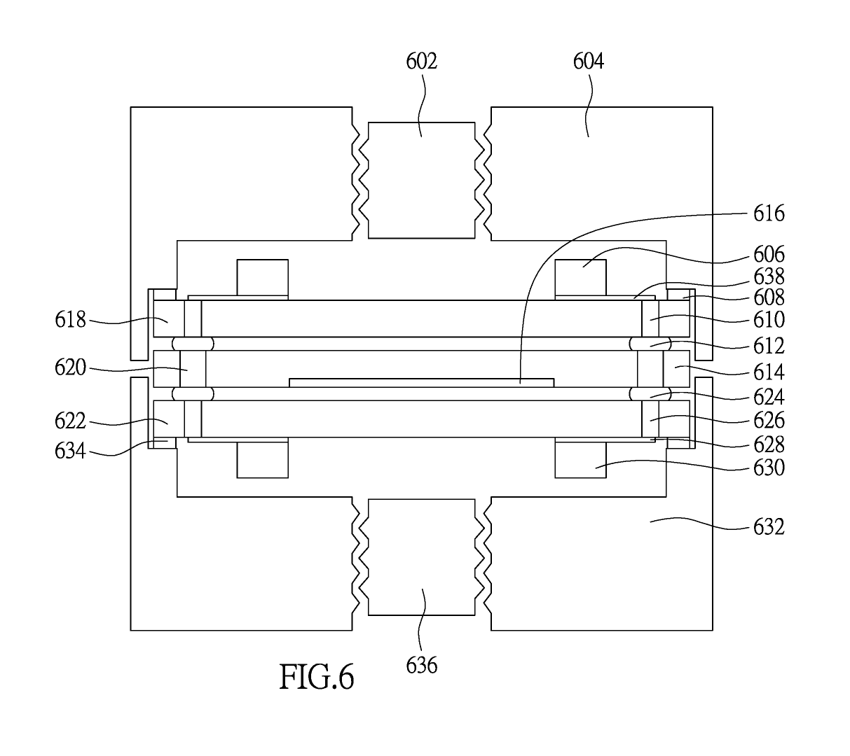

In an embodiment of the disclosure, the front lens, the image sensing module and the back lens can be formed as a wafer-level photograph taking module to achieve the device with the front lens and the back lens using the same image sensing module described above. FIG. 6 shows a schematic view of a wafer-level photograph taking module of an embodiment of the disclosure. As shown in FIG. 6, the element corresponding to the front lens of the wafer-level photograph taking module is a first lens 602, wherein the first lens 602 is supported by the first lens supporting frame 604 and the first lens supporting frame 604 is bonded to a first substrate 618 through a first adhering layer 608. The first substrate 618 is formed with a first conductive line 638 thereon and is formed with the first conductive plug structure 610 therein. The first conductive via structure 610 is electrically connected to the first electronic device 606 through the first conductive line 638. An image sensing chip 614 is disposed below the first substrate 618, wherein the first image sensing chip 614 comprises a sensing region 616 and at least one through silicon via structure 620. The through silicon via structure 620 is electrically connected to the first conductive via structure 620 through the first conductive layer 612 and is further connected to the first electronic device 606.

A second substrate 622 is disposed below the image sensing chip 614, wherein a second conductive via structure 626 is disposed in the second substrate 622, and the second conductive via structure 626 is electrically connected to the through silicon via structure 620 in the image sensing chip 614 through the second conductive layer 624. A second conductive line 628 and a second electronic device 630 are formed on the bottom surface of the second substrate 622, wherein the second conductive layer 624 is electrically connected the second conductive via structure 626 and the second electronic device 630. A second lens supporting frame 632 is disposed below the second substrate 622. The second lens supporting frame 632 is bonded to the second substrate 622 through the second adhere layer 634, and the second lens supporting frame 632 is formed with a second lens 636 therein.

According to the wafer-level photograph taking module with double side semiconductor technology such as a through silicon via, the first lens 602 and the second lens 636 on the reverse side of the image sensing chip 614 can use the image sensing chip 614. Therefore, compared to traditional art, the disclosure can save the cost of an image sensing chip.

According to the description above, the disclosure has advantages as follows. The front lens and the back lens of the mobile device use the same image sensing module. Therefore, cost of one image sensing module is saved and the space of one image sensing module is saved. Accordingly, a mobile device which is thinner, smaller and lighter than the conventional device is achieved to fit the current requirement. In addition, since the first photograph taking assembly in accordance with the front lens uses the same image sensing module as the second photograph taking assembly in accordance with the back lens, both the first photograph taking assembly and the second photograph taking assembly can use an image sensing module having high image quality. Accordingly, the pictures taken by the first photograph taking assembly and the second photograph taking assembly have high quality.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A mobile device, comprising:
a housing comprising an accommodation space;
an image sensing module disposed in the accommodation space of the housing;
a front lens disposed in the accommodation space of the housing, wherein the front lens faces a first direction; and
a back lens disposed in the accommodation space of the housing, wherein the back lens faces a second direction;
wherein the image sensing module is commonly used by the front lens and the back lens.

2. The mobile device as recited in claim 1, wherein the first direction is a reverse direction of the second direction.

3. The mobile device as recited in claim 1, further comprising a back cover fastened with the housing.

4. The mobile device as recited in claim 1, further comprising a printed circuit board disposed in the accommodation space of the housing.

5. The mobile device as recited in claim 4, wherein the image sensing module is an image sensing chip formed on the printed circuit board.

6. The mobile device as recited in claim 5, wherein the image sensing device comprises a first surface and a second surface, the first surface is reverse to the second surface, the front lens is adjacent to the first surface of the image sensing chip, and the back lens is adjacent to the second surface of the image sensing chip.

7. A smart phone, comprising:
a housing comprising an accommodation space;
an image sensing module disposed in the accommodation space of the housing;
a front lens disposed in the accommodation space of the housing, wherein the front lens faces a first direction; and
a back lens disposed in the accommodation space of the housing, wherein the back lens faces a second direction, wherein the image sensing module is commonly used by the front lens and the back lens;
a printed circuit board disposed in the accommodation space; and
a screen disposed on the housing.

8. The smart phone as recited in claim 7, wherein the first direction is a reverse direction of the second direction.

9. The smart phone as recited in claim 7, wherein the front lens and the image sensing module forms a first photograph taking assembly, the back lens and the image sensing module forms a second photograph taking assembly, the first photograph taking assembly and the second photograph taking assembly have the same pixel value.

10. The smart phone as recited in claim 7, wherein the image sensing module is an image sensing chip formed on the printed circuit board, the image sensing chip comprises a first surface and a second surface, the first surface is a reverse surface of the second surface, the front lens is adjacent to the first surface of the image sensing chip, and the back lens is adjacent to the second surface of the image sensing chip.
